(19) United States
(12) Patent Application Publication
(10) Pub. No.: US 2009/0017889 A1
(43) Pub. Date: Jan. 15, 2009

(54) CHESS PLAYING METHOD AND DEVICE FOR CARRYING OUT SAID METHOD

(76) Inventors: Aleksandr Dmitrievich Zhukov, Moscow (RU); Valeriy Filippovich Ivanov, Moscow (RU); Shamil Anvyarovich Tarpischev, Moscow (RU); Vyacheslav Aleksandrovich Fetisov, Moscow (RU)

Correspondence Address: LADAS & PARRY, 5670 WILSHIRE BOULEVARD, SUITE 2100, LOS ANGELES, CA, 90036-5679, US

(21) Appl. No.: 12/091,334

(22) PCT Filed: Oct. 25, 2005
(86) PCT No.: PCT/RU2005/000521

§ 371 Date: Sep. 26, 2008

(51) Int. Cl. G06F 19/00

(52) U.S. Cl. 463/14

(57) ABSTRACT

The invention relates to chess game playing method, in particular to a novel type of a chess game between two pairs of players. The inventive chess game playing device comprises at least two playing fields (7) which are divided into squares of two alternating colours, two sets of chess pieces, each of which consists of two groups (8, 9) of chess pieces (10-15) and two chess-clocks (2) each of which is provided with a timer (39) connected to two displays (3, 4) and to a control unit (41) which is used for switching said displays (3, 4). The chess game playing device also comprises means for exchanging data related to the location of the chess pieces (10-15) on the playing fields (7), each chess-clock (2) comprises a device for locking the control unit (41), wherein all timers (39) are interconnected.

### FIELD OF THE INVENTION

The invention relates generally to a chess game, more specifically to a novel chess game, in particular to a method and device for playing a chess game between two pairs of players.

### BACKGROUND OF THE INVENTION

In a traditional method of playing chess between two players the players alternatively move chess pieces on a game board (playing field) comprising 64 equal squares of alternating light and dark colors. Chess clocks are used to limit the time for thinking over the moves in chess competitions, each of the chess clocks having a timing unit connected to two displays and a control unit. At the start of the game each player has the same number of chess pieces and pawns, one player having light-color (white) pieces and the other player having dark-color (black) pieces. Each set of chess pieces includes: one king, one queen, two rooks, two bishops, two knights and eight pawns. White starts the game; the right to play with white pieces is generally decided by a game of chance. A player must move one piece at a time, with the exception of castling. Omission of moves is prohibited. This combination of chess game features has been retained almost in all variants of improved chess games, because they are substantially aimed at structural embodiments or insignificant modification of chess game rules. Consider three examples of improved chess game variants. A first variant disclosed in U.S. Pat. No. 6,203,016 BA (Cl.7 A63F 3/02, 1999) is a method of playing chess intended to add more interest to the game process owing to insignificant modification in the above rules. The second variant disclosed in U.S. Pat. No. 6,382,626 BA (Cl.7 A63F 3/02, 2000) is a device and method for playing chess, wherein central pawns differ from the other pawns not only in size, but also in a way of moving across the chess board. In a third variant disclosed in U.S. Pat. No. 6,702,287 (Cl.7 A63F 3/02, 1999) a device and method for playing chess use a game board having 110 black and white squares. Similarly to the traditional chess game, at the start of the game the players have equal number of pieces and pawns, one player having light-color pieces, and the other one having dark-color pieces. A feature of this device is that each of the chess sets includes seventeen additional pieces which are not obligatory chess pieces.

The aforementioned devices and methods of playing chess between two players suffer from low audience appeal associated with the lack of team contest. This is explained by the fact that the current chess game process is mathematically formalized to a great extent, i.e. it is practically devoid of “mystery”. To put it differently, the current chess game is reduced to a contest between two players who only repeat, in the best case, computer-predicted chess moves at critical moments of the game. That is why a team game in which a single chess game is played between two teams, each consisting of a plurality of players, is of main interest for chess fans. Rather many attempts to overcome this problem have been made for the moment. By way of example, in U.S. Pat. No. 5,586,762 (Cl.6 A63 F 3/02, 1994) four sets of chess pieces are used for a chess game played between several teams at a time, each of said sets being provided with marks distinguishing pieces of one group from pieces of the other groups; and a square game board comprises a central matrix of sixty-four squares and four side regions, each including sixteen squares. Players alternatively move a piece according to the standard rules of chess, attempting to advance pawns to the edge rows of the squares in the central matrix. U.S. Pat. No. 6,260,848 BA (Cl.7 A63F 3/02, 2000) describes a device for playing chess between four players, comprising a game board of 144 squares of two alternating colors. In some prior art devices adapted for playing a game between more than two players, several game boards are used. For example, WO 38805 A1 (Cl.7 A63F 3/02, 1999) discloses a device for playing chess which differs from the traditional game in that three or four players play on three or four game boards at the same time. However, the aforementioned and other known methods of playing a chess game between two teams suffer from low entertaining appeal. This is primarily explained by the fact that players members of the same team can cooperate and this excludes the basic feature of pair game—the need of taking an independent decision by each player in the pair at a respective time in the game. Other deficiencies of traditional systems will be discussed in the following description. In light of the aforementioned, the object of the invention is to overcome the shortcomings mentioned above.

### SUMMARY OF THE INVENTION

The object of the present invention is to provide a method of playing a chess game which can be played by at least two pairs of players, and a device for carrying out the method.

The object is attained in a device for playing a chess game comprising: at least two playing fields which are divided into squares of two alternating colors; two sets of chess pieces, each set consisting of two groups of chess pieces; and two chess clocks, each chess clock including a timing unit connected to two displays and to a control unit; said device for playing a chess game further comprises means for exchanging data related to positions of chess pieces on the playing fields, and each chess clock comprises a device for locking the control unit, wherein all timing units of the chess clocks are linked together.

The above device can be used to implement a method of playing a chess game including alternatively moving, by players, members of a first or second team, a chess piece on a playing field during a time limit allotted to each player, said method further comprising: using in said set of chess means respective locking devices, e.g. a device for locking the switching of a chess clock by a player; setting a time limit for the first and second team, and setting the turn of moves of a chess piece by players by locking access to a predetermined chess means at a respective time.

A distinctive feature of the present invention is a chess computer included as at least one player in a first or second team. Other features and advantages of the invention will become apparent from the following detailed description, as well as from claims 1 to 16.

### BRIEF DESCRIPTION OF DRAWINGS

The invention will be further explained with reference being made to the attached drawings wherein:

FIG. 1 is a general plan view of a chess table;

FIG. 2 is a schematic diagram of a device for playing a chess game between two pairs of players in a first embodiment;

FIG. 3 is a schematic diagram of a piece position sensor;

FIG. 4 is a first embodiment of circuitry of two chess clocks;

FIG. 5 is a second embodiment of circuitry of two chess clocks;

FIG. 6 is a circuit showing how chess clocks are connected to a piece position sensor;

FIG. 7 is a schematic diagram of a device for playing a chess game between two pairs of players in a second embodiment;

FIG. 8 is a schematic diagram of a device for playing a chess game between two pairs of players in a third embodiment;

FIG. 9 is a schematic diagram of a device for playing a chess game between two teams, each team including a chess computer as a player;

FIG. 10 is a schematic diagram of a device for playing a chess game between two pairs of players, wherein one of the players in each team is a chess computer;

FIG. 11 is a general view of portable devices for playing chess between two pairs of players;

FIG. 12 is a flow diagram illustrating an algorithm of playing a chess game.

### DETAILED DESCRIPTION OF THE PREFERRED EMBODIMENTS

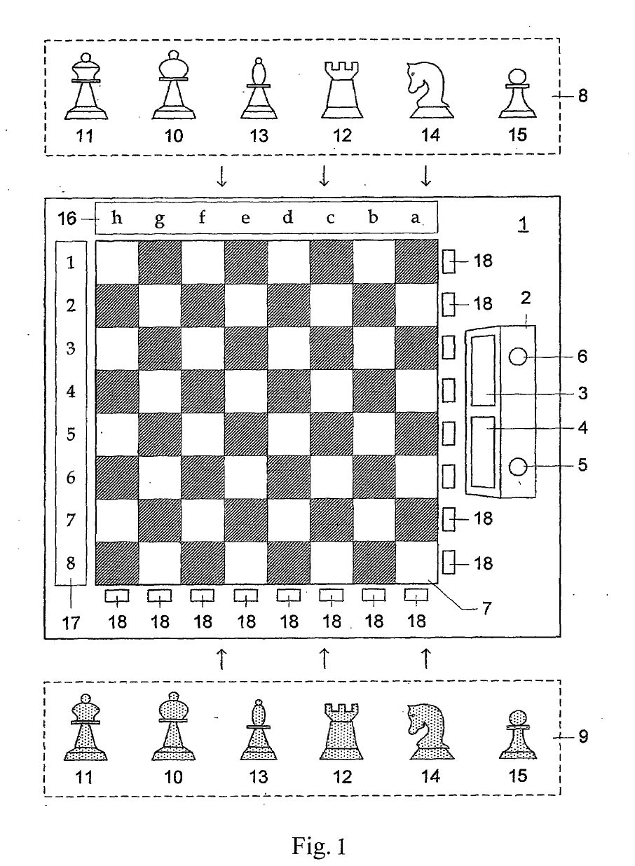

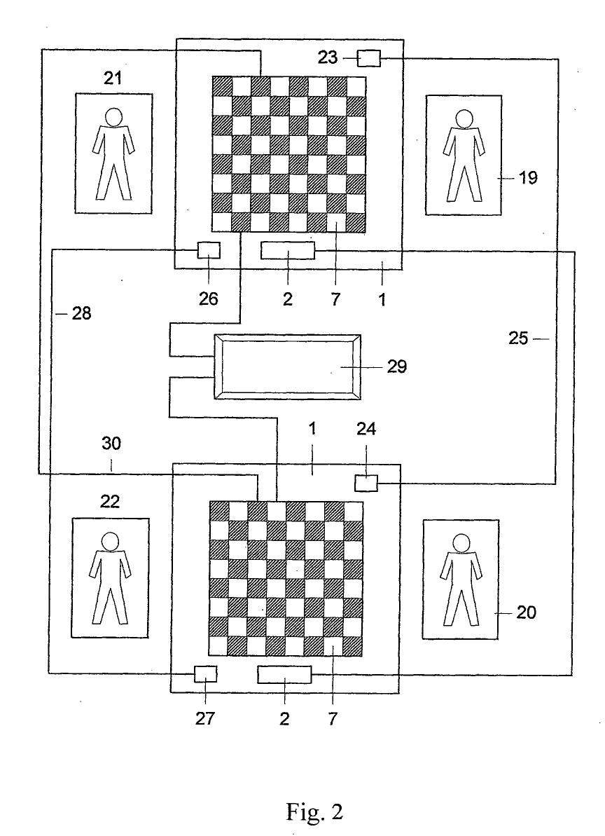

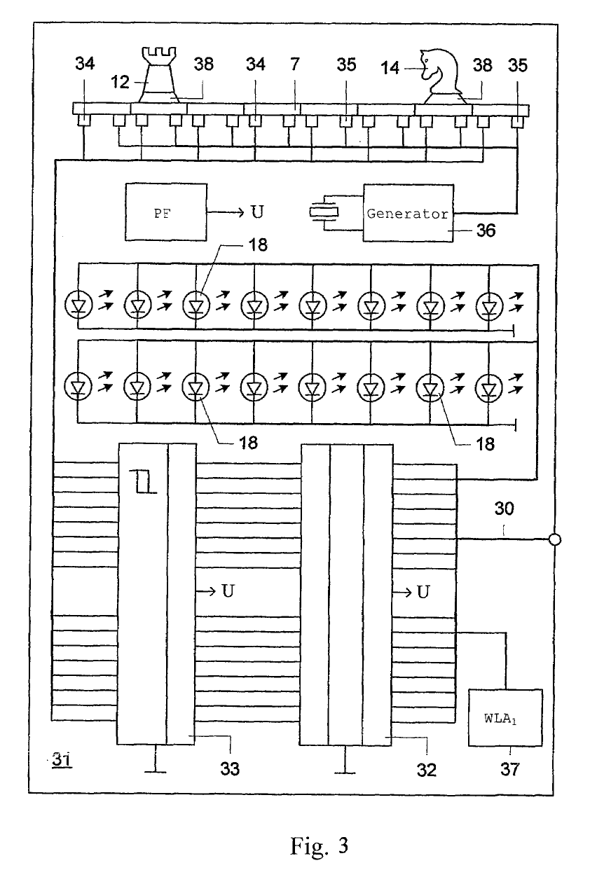

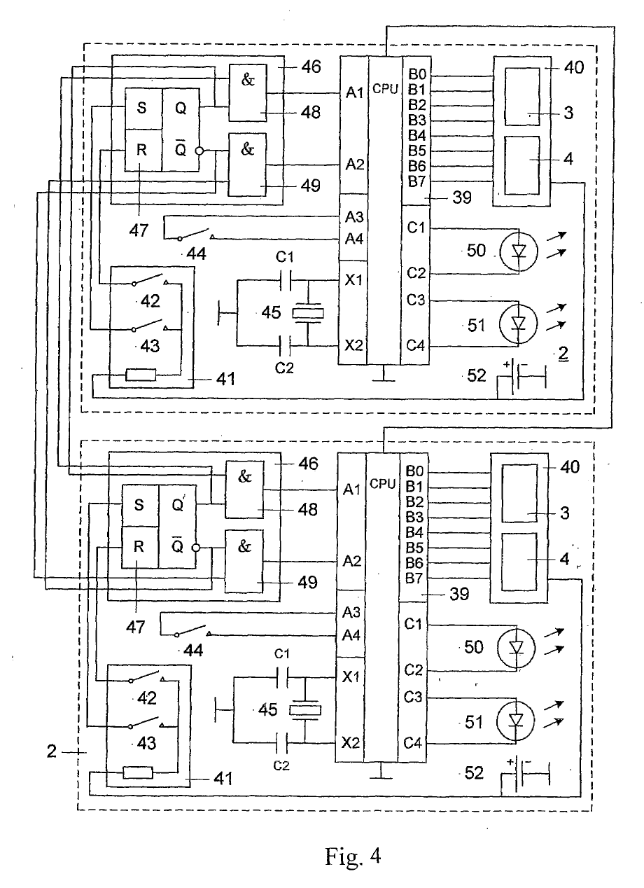

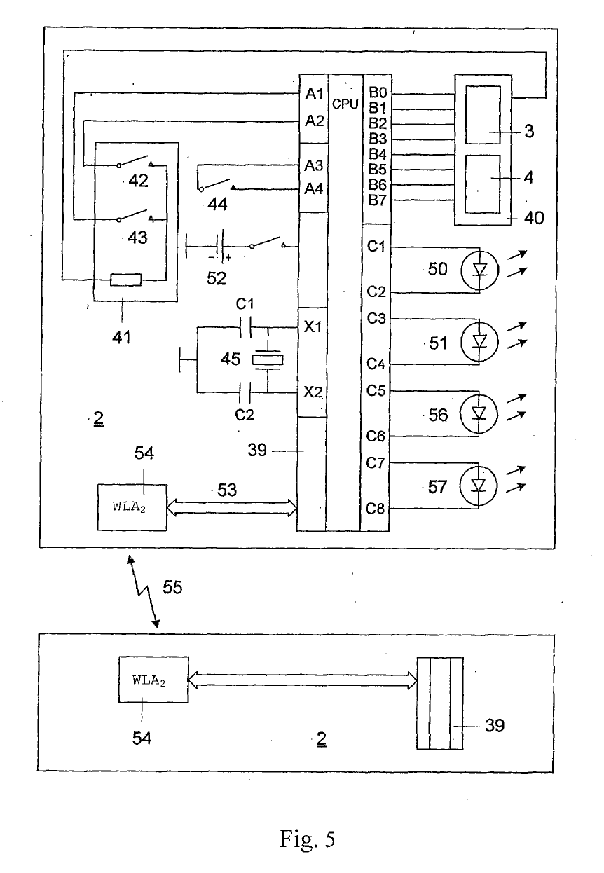

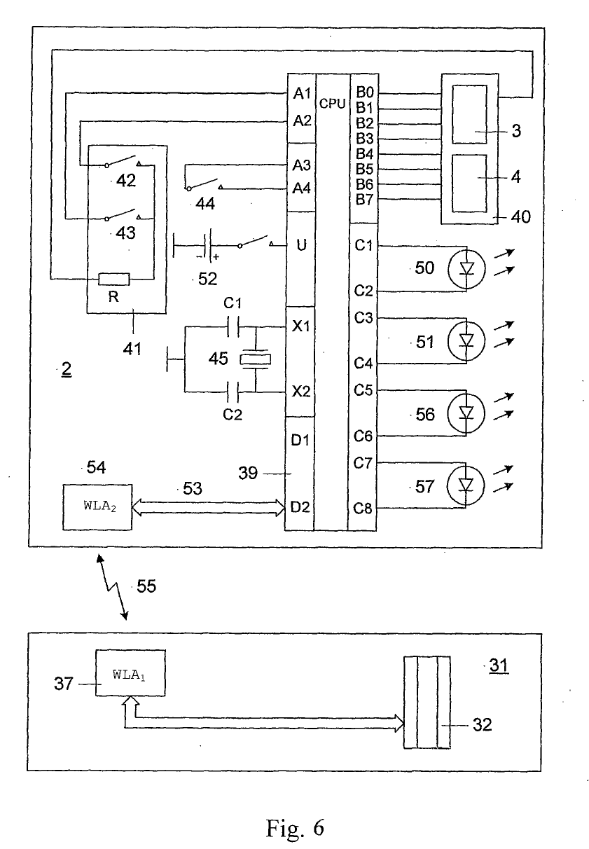

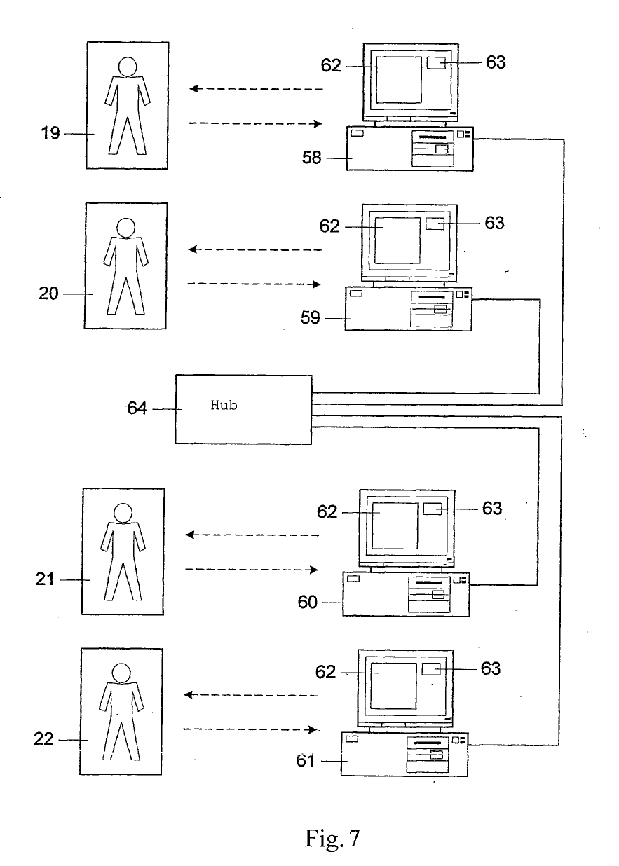

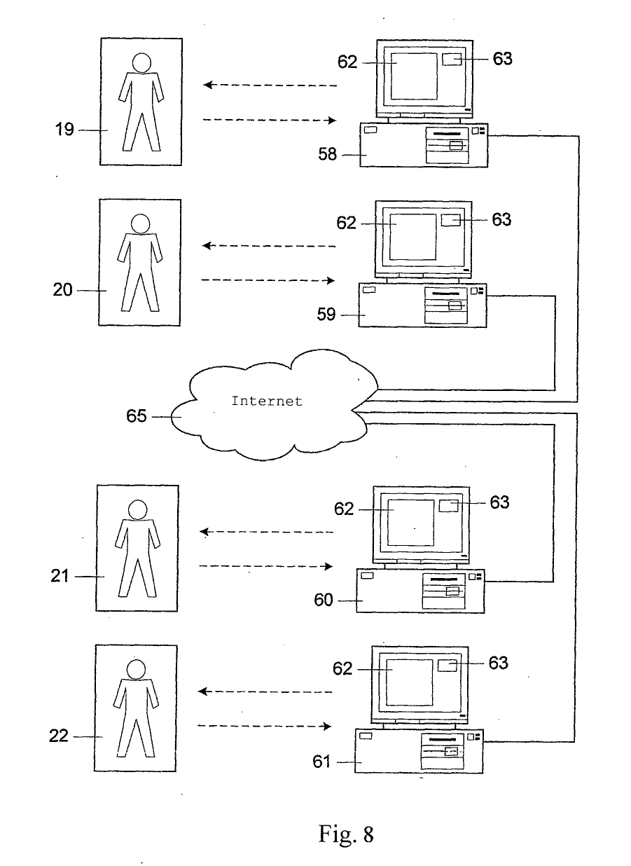

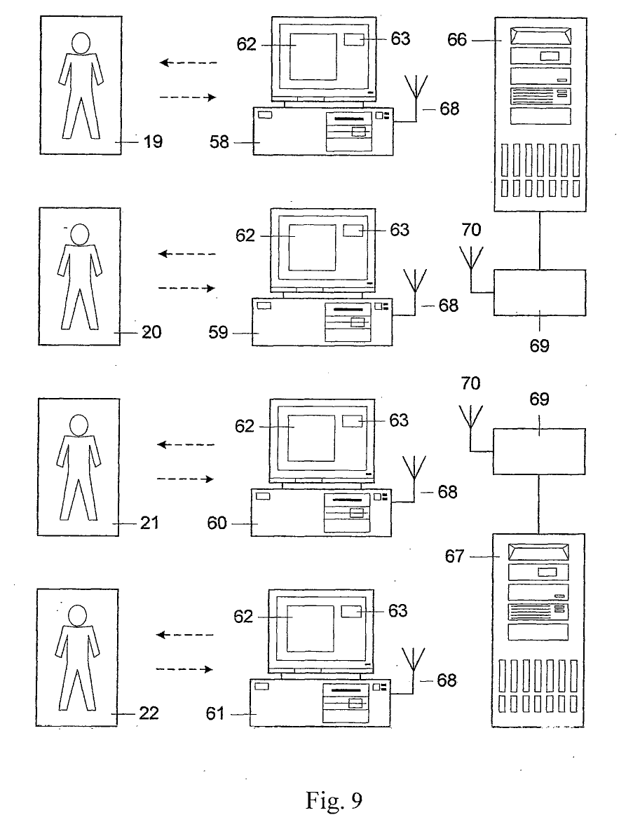

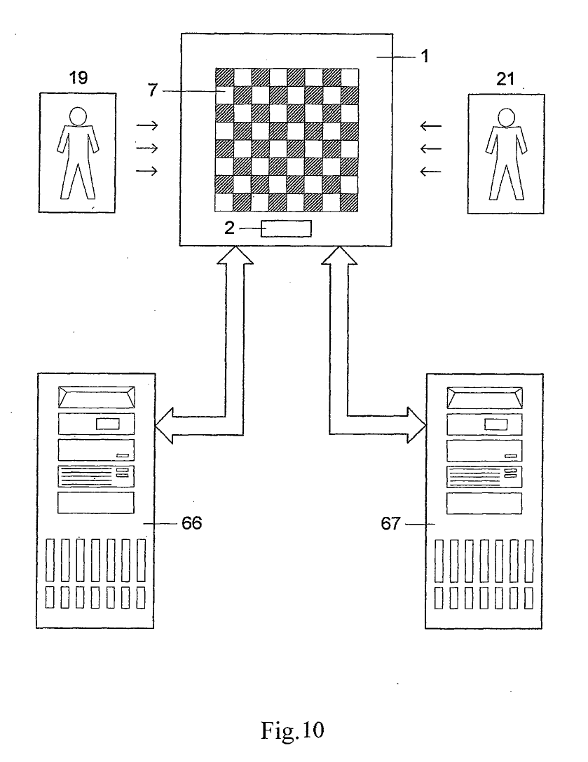

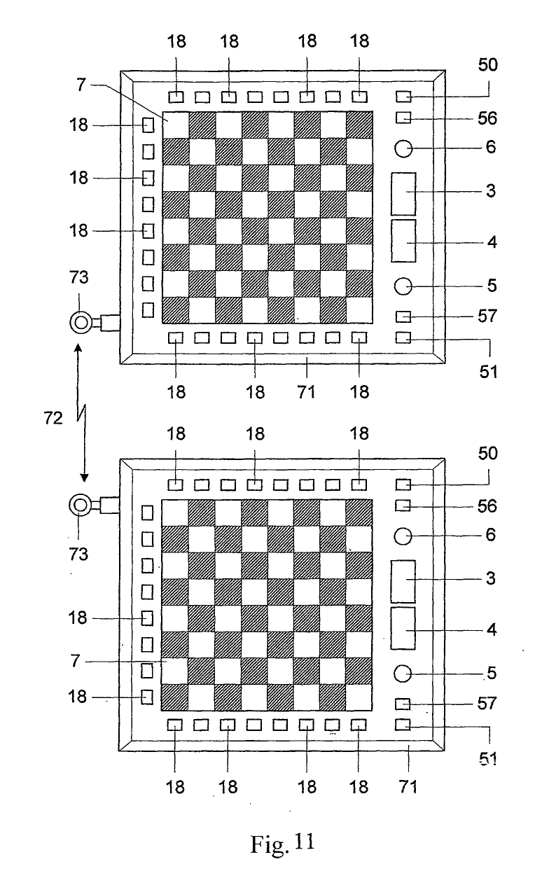

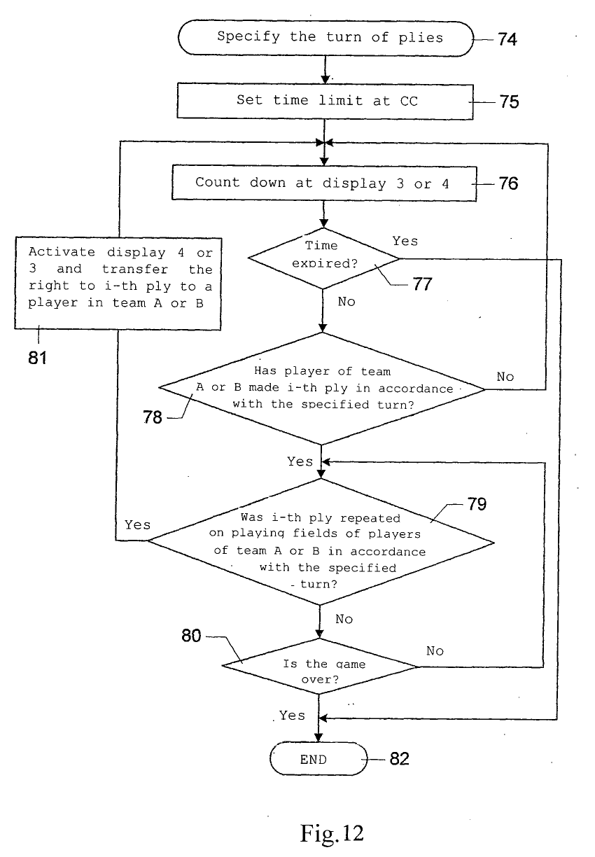

In further description of the preferred embodiments of the invention, the underlined terms will be replaced with abbreviations shown in brackets. FIG. 1 shows a chess table (CT) 1 on which chess clocks (CC) 2 having two displays: a display (DIS) 3 and DIS 4 are arranged; a count down process at DIS 3 is started by pressing a button 5, and a count down process at DIS 4 is started by pressing a button 6. At the count down start at DIS 3, DIS 4 registers the time accumulated during the game, and vice versa, at the count down start at DIS 4, DIS 3 registers the time accumulated during the game. Depicted on the chess table 1 is a playing field (PF) 7, a square field divided into squares of two alternating colors. Light-color squares are referred to as white fields, and dark-color squares are referred to as black fields. The set of chess pieces includes two groups of chess pieces. A first group 8 includes light-color (white) pieces, and a second group 9 includes dark-color (black) pieces. Each group of chess pieces includes: a king 10, a queen 11, two rooks 12, two bishops 13, two knights 14 and eight pawns 15. In addition to PF 7, two fields 16 and 17 can be depicted on the CT 1, comprising conventional signs used to designate each field, e.g. when recording separate game moves. According to the rules of algebraic chess notation, the field 16 comprises letters of Latin alphabet (from “a” to “h”), and the field 17 comprises ciphers (from “1” to “8”). In addition, each chess piece has its letter notion: King K, Queen Q, rook R, bishop B, knight N; notation p for pawns is used only to record positions, and omitted in records of the game. To indicate white and black fields, light-emitting diodes 18 are provided on the surface of the CT 1 in parallel with the fields 16 and 17. FIG. 2 shows a general view of a device for playing a chess game between two pairs of players at two CTs 1. A first player (FP_{A}) 19 and a second player (SP_{A}) 20 are members of a first team (team A); a first player (FP_{B}) 21 and a second player (SP_{B}) 22 are members of a second team (team B); communication between players in each team is prohibited. A feature of the device is that the CCs 2 located on two CTs 1 communicate through various communication means described below. To transmit information about a move that was made, each player can use data exchange means (DEM) adapted to exchange data, between players 19, 20, about positions of chess pieces 10, 11, 12, 13, 14, 15 on the playing fields 7. In the present case, one of the DEMs comprises two linked digital displays (DDIS) to show the position of a chess piece, in particular, a first DDIS₁ 23 and second DDIS₂ 24. DDIS₁ 23 and DDIS₂ 24 communicate via a link 25. Another DEM, comprising a third DDIS₃ 26 and a forth DDIS₄ 27 communicating via a link 28, serves to exchange chess moves between FP_{B} 21 and SP_{B} 22. Piece position information may be entered in a respective DDIS either automatically or by a player entering a respective algebraic chess notation with the aid of an input device. It should be noted that a variety of electronic devices that can be used as DEM are commercially available. They include, in particular, a mobile telephone (MT) and pocket personal computer (PPC). PPC can be also referred to as a personal digital assistant, palm personal computer, portable computer. Consider a peculiarity of using the latter in the DEM. An input device in the PPC relies either on its keys or on the screen with a special sensitive layer and a protective film applied thereon. A player may enter piece position information by writing a chess notation on the screen. A dedicated software installed in the PPC recognizes the handwritten letters and digits and then sends them to another PPC via link 25 or 28. A plastic stylus is used to write text data and operate on the PPC screen by touching the screen surface (which is pressure sensitive). If both PPCs have an IR-port, Bluetooth or Wi-Fi module, links (channels) 25, 28 between them can be wireless. DEM can be also a pen with a miniature TV camera connected to a means for recognition letters or digits written on paper. If no means of such kind is available, a digital pen, PC Notes Taker, can be used to enter graphic information or hand-written text in a computer. The main feature of this embodiment is that a player writes with the digital pen on a plain paper, and the exact copy of the record appears immediately on the screen of an appropriate PPC 23, 24, 26, 27. This result is provided by the fact that the pen sends an IR signal to a receiver integrated in a base unit. The base unit is a detachable device comprising an IR receiver, which is attached to the piece of paper. DEM can be also one or more display boards 29 connected to the PF 7 and comprising a piece position sensor_(PPS). If two PFs 7 are used, a link 30 should be provided between them. FIG. 3 shows an embodiment of PPS 31 circuitry. The PPS 31 includes a microcomputer (MC) 32 and a comparator module (CM) 33 comprising sixty four voltage comparators. The microcomputer 32 operates on digital data encoded as zeroes and ones at the output of the CM 33. Analog part of the PPS 31 comprises sixty four pairs of conductive plates 34, 35 overlying each of the white and black fields of the PF 7. Plates 35 are connected to output of a generator 36, while each of the plates 34 is connected to a respective input of the voltage comparator included in the CM 33. Furthermore, light-emitting diodes 18 and a wireless adapter (WLA₁) 37 that replaces the wire link 30 by a wireless one are connected to output of the MC 32. The wireless adapter includes a transceiver coupled to an output of the MC 32 via a digital modulator and to an input of the MC 32 via a clocking unit. The latter is used to recover digital data present at the output of the MC 32 at the instant of transmission thereof to another PF(s) 7. It should be noted that the transceiver may be a standard Bluetooth 1.1. device, such as D-Link DBT-900AP. The generator 36 of the microcomputer 32 and CM 33 are supplied from own power supply (PS). For normal functioning of the PPS 31, the lower part 38 of chess pieces must be conductive. PPS 31 operates in the following manner. Initially, the MC 32 stores original positions of chess pieces. After each move of a piece discrete signals appear at output of a respective comparator, and MC 32 determines from them a new position of the piece on the PF 7. All the moves of chess pieces on a PF 7 are accompanied by generation in the MC 32 of signals which are transmitted via WLA₁ 37 to another PFs 7. After each change in a chess piece position on the PF 7 two light-emitting diodes (LED) 18 light, one of the LEDs being in the vicinity of the field 16, and the other one in the vicinity of the field 17. The LEDs light on several PFs 7 at once, the mode of LED activation being specified by the MC 32 software. Generation of a discrete signal at the comparator's output is caused by a change in the variable voltage at its input after a piece move. Each move of a chess piece alters the capacitance between plates 34, 35, hence the value of the variable voltage part output from the generator 36 to the input of a respective comparator changes as well. Response voltage of comparators in the CM 33 is chosen such that in case of appearance of a chess piece, a discrete signal corresponding to logical one appears at the respective comparator output. The capacitance C_{N} between plates 34, 35 changes when a chess piece is present owing to the additional parallel connection to C_{N} of two series-connected capacities C_{F}¹ and C_{F}², where C_{F}¹ is the capacity whose plates are plate 34 and the lower part 38, and C_{F}² is the capacity whose plates are plate 35 and the lower part 38. FIG. 4 shows two circuits of CCs 2 for generating all electric signals required for operation of the CCs 2. Each circuit includes: a timing unit (TU) 39 coupled to a displaying module 40 comprising two displays: DIS 3 and DIS 4, and to a control unit (CU) 41. The latter comprises (initially) open contacts 42, 43 coupled to buttons 5, 6. Operation parameters of CC 2, e.g. time limit T_{C}, are set by closing contacts 44. The TU 39 includes two counters for accumulating the game time, the counters being connected to a common pulse generator whose frequency is set by a quartz resonator 45. It should be noted that the timing unit 39 can be a timing microprocessor (TMP), such as SMC 6280 available from Seiko Epson. In this case the TU 39 operation algorithm is stored in the TMP memory in its manufacture. In addition to the aforementioned components, CC 2 comprises a locking device (LD) 46 for locking the control unit 41. The locking device 46 comprises a trigger 47 and two logical coincidence circuits (LCC) 48, 49, the upper input of the LCC 48 on the circuit being a control input of the LD 46. It is seen from the drawing that in this embodiment of the CC 2, TUs 39 are linked together via the LD 46. The circuit further comprises LED 50 and LED 51. The former is to indicate activation of DIS 3, and the latter is to indicate activation of DIS 4. CC 2 is supplied from a battery 52. FIG. 5 shows a second embodiment of CC 2. In this embodiment LD 46 is implemented in the TU 39 software and includes an input/output device (I/O) connected via a bus 53 to a wireless adapter (WLA₂) 54 whose parameters are matched with that of WLA₂ 54 of the other CC 2. Thus, I/Os of TUs 39, such as TMP, are linked together via wireless link 55. The CC further includes additional LEDs 56, 57 to indicate activation of the LD 46. FIG. 6 shows an embodiment of a chess clock wherein WLA₂ 54 is matched with WLA₁ 37 included in one or more PPS 31. Such connection enables locking an appropriate button 5,6 of the CC 2 when a player in one team erroneously repeats a move on his PF 7. This event can be indicated by one of LEDs 56, 57. Another possible function of LEDs 56, 57 is to indicate locking activation mode, in which mode the depression of e.g. the button 5 when LED 57 is activated will not result in switching the CC 2. FIG. 7 shows a device for playing a chess game between two pairs of players, wherein playing fields and chess clocks are implemented in the following service computers (SC): SC₁ 58, SC₂ 59, SC₃ 60, SC₄ 61. Each of the SCs comprises: a virtual playing field (VPF) generation unit 62, a virtual chess piece (VCP) set generation unit and a virtual chess clock (VCC) generation unit 63. These units generate, on a display of each SC, a set of chess means in the form of a VPF 62 with VCPs and VCCs 63 located thereon. It should be noted that one of the SCs or PPS 31 may comprise a LD for locking a piece move on the PF 7 or VPF 62, such as a DEM locking unit for locking DEM related to positions of chess pieces on the PF 7 or VPF 62. To exchange data, SCs 58, 59, 60, 61 are linked together through a network channel, such as Ethernet or local wireless network. In the former case, SCs 58, 59, 60, 61 can be linked together using adapters, T-connectors and a hub 64. It should be noted that the local network can be a computer network concentrated in a single building, the residence of the World Chess Federation (FIDE). If SCs 58, 59, 60, 61 are linked by the Internet 65 (FIG. 8), they can be generally located at any point on the Earth. In conclusion it may be said that if every SC includes means for locking a piece move on the VPF 62, the control inputs thereof are also linked via a hub 64 or the Internet 65. FIG. 9 shows a device for playing a chess game between two teams, each team including three players, wherein one the players in each team is a chess game computer (CGC). Therefore, a first team (team A) includes a first player (FP_{A}) 19, a second player (SP_{A}) 20 and a third player (TP_{A}) such as a first chess game computer (CGC₁) 66, and a second team (team B) includes a first player (FP_{B}) 21, a second player (SP_{B}) 22 and a third player (TP_{B}) such as a second chess game computer (CGC₂) 67. To exchange data between SC₁ 58, SC₂ 59, SC₃ 60, SC₄ 61, internal wireless adapters such as D-Link DW L-G520 are used, operating at frequencies in the range from 2.4 GHz to 2.483 GHz and having an external antenna 68. Chess game computers CGC₁ 66 and CGC₂ 77 are, in turn, connected to an external wireless adapter 69 such as Eline ELW-9610SXg-Wireless LAN Broadband Router 9610SX-g54M having an external antenna 70. FIG. 10 shows a device for playing a chess game between two teams, each including two players, wherein one of the players in each team is own personal CGC connected to MC 32 included in PPS 31. The latter comprises in particular a PF 7. Therefore, team A includes a first player FP_{A} 19 and second player, CGC₁ 66, and the team B includes a first player FP_{B} 21 and second player, CGC₂ 67. FIG. 11 shows two portable devices (PD) 71 for playing a chess game, that are linked via a wireless link 72 including removable external antennas 73. The portable devices 71 are designed for playing chess between at least two pairs of players. In addition to the removable external dipole antenna 73, the portable device 71 also comprises an internal antenna. Portable devices 71 for playing chess are designed for amateur chess players and for secondary schools as an effective chess game tutorial and means for improving intelligence level of students. The device comprises a PPS, an electronic CC 2 having DIS 3 and DIS 4, and LEDs 50, 51, 56, 57. A basic feature distinguishing the device from that shown in FIG. 1 is that PPS 31, CC 2, PF 7, MC 32 and WLA₁ 37 are all integrated in a single housing. Another distinctive feature of PD 71 is an additional row of LEDs 18 replacing the field 16. PD 71 further comprises internal wireless adapters operating under the conventional Bluetooth or Wi-Fi standard. Both standards generate electromagnetic radiant flux at a frequency within the range from 2.4 to 2.48 GHz. The term “Wi-Fi” refers to a variety of wireless local network standards. The internal wireless adapters and link 72 enable communication between means included in the PD 71, such as PPS 31 and CC 2. In an embodiment of PD 71, the integrated MC 32 can perform the functions of not only PPS, but also of TU 39. In this case all of the aforementioned locking devices can be implemented in the MC 32 software. Here, the turn of moves of chess pieces 8,9 by players is specified by a special service routine stored in memory of MC 32 and matched with a service routine of another PD 71. A device for playing a chess game operates in accordance with an algorithm shown in FIG. 12. The algorithm can be practiced using a dedicated and standard software stored in read-only memories of the following means: 2, 23, 24, 26, 27, 32, 39, 58, 59, 60, 61, 66, 67, 71. The device for playing chess starts its operation after step 74 of generating a turn N(N=1, 2, . . . ) of plies to be made by players. The term “ply” (or half a move) refers to N-th move made by one party only. To simplify the following description the following notations will be used: N_{W} is a ply made by white pieces, and NB is a ply made by black pieces. A ply turn routine can be also stored in read-only memories of the following means: 2, 23, 24, 26, 27, 32, 39, 58, 59, 60, 61, 66, 67, 71. Saying it differently, the turn of moving pieces by players is specified by storing a service routine in a memory of a respective chess means. The turn of plies N_{w}, N_{b} is determined beforehand in accordance with the rules set for given chess game. Consider possible variants of the turn of plies in a chess game between two teams, each team including two players, i.e. a team A (white pieces) includes players FP_{A} 19 and SP_{A} 20, and a second team B (black pieces) includes FP_{B} 21 and SP_{B} 22. From here on, the turn of N-th ply for given player will be indicated in brackets, i.e. record SP_{A}(2N_{w}) means that a player SP_{A} with white pieces must make all even plies N_{w}: N_{w}=2, 4, . . . N_{w}^{E}, where N_{w}^{E} is the last ply with white pieces in the game. It should be noted that the turn of moves can be generally specified using not only a deterministic law, but a random law either. The latter may include such factors as player's rating “r”; number k (k=2, 3, . . . ) of players in a team; total running time t spent by a player during the game, etc. In the latter case, the record may be: SP_{A}(N_{w}=F(t,k,r)), where F(t,k,r) is the probability that the right to ply will be given to the player SP_{A} having rating “r”. It is evident that the choice of the function type may influence the strategy of cooperation between the players in the same team. For example, if probability F(t,k,r) increases with reduction in t value, to obtain preference in the pair game a player with a higher rating must play faster than his partner in the team. The invention will be further described with reference to a device for playing a chess game between two teams, a first team including players FP_{A} 19 and SP_{A} 20, and a second team including players FP_{B} 21 and SP_{B} 22. The turn of plies will be as follows: FP_{A}(2N_{w}−1), SP_{A}(2N_{w}), FP_{B}(2N_{b}−1), SP_{B}(2N_{b}). With a device having the structure shown in FIG. 2, after a time limit T₀ has been set by closing contacts 44 on both CCs 2 and with the CCs running (step 75), count down starts simultaneously at two CCs 2 (step 76). The count down at CCs 2 can be synchronized by various methods, e.g. using a single master oscillator that provides pulses to the other CCs 2 via a wireless link 55. In another embodiment master oscillators included in MC 32 can be symphonized via this link. At both CCs 2 the count down of accumulated time T after activation (step 76) terminates at DIS 3 after duplicating on both PFs 7 the chess move and pressing button 6 at both CCs 2. At the instant of count down completion, DIS 3 registers value (T₀−t*), where t* is the time spent for one move, then count down starts at DIS 4. It terminates after pressing buttons 5 (not obligatory at the same time). Thus, after specifying the above turn of moving chess pieces 10, 11, 12, 13, 14, 15 by players FP_{A}, SP_{A}, FP_{B}, SP_{B}, the device will function in the following manner. Assume that the game is played on two PDs 71, wherein FP_{A}, FP_{B} play at a first PD (PD₁), and SP_{A}, SP_{B} play at a second PD (PD₂). Assume further that the player FP_{A} 19 gets the right to 9-th ply during the game; at this instant his DIS 3 reads: 17 min 42 sec, LED 57 at PD₂ and LEDs 56, 57 at PD₂ are activated, i.e. light. Lighting of the LEDs means that button 5 at PD₁ and buttons 5, 6 at PD₂ are locked, i.e. depression of the buttons will not result in switching the CC. Then according to the specified turn the player FP_{A} makes 8-th ply with white knight (N_{w}=9) “9.Nc3-e2” and presses the button 6 of the CC 2 (“Yes” at step 78); at the instant of this depression DISs 3 of both CCs 2 read: 14 min 36 sec. After transmission of the ninth ply via link 72 and respective activations of LED 18 at PD₂ the player SP_{A} repeats the ply “9. Nc3-e2” at his PD₂ and then presses button 6 of his CC 2 (“Yes” at step 79). Only after this event both CCs 2 switch simultaneously (step 81) i.e. the right to ply N_{b}=9 passes to the player FP_{B} (step 81). Note that immediately after repeating the 9-th ply by the player SP_{A} LED 56 at PD₂ goes out, and after pressing the button 6 it lights again. As mentioned above, in case of incorrect repetition of the ply, LED 56 will remain activated, and both CCs 2 will remain in the original count down state at DIS 3 despite the depression of the button 6 at PD₂ by SP_{A}. Due to a delay τ (τ>0) in the repetition of 9-th ply by the player SP_{A}, at the instant of his depression of the button 6 DISs 3 of both CCs 2 read: 14 min 35 sec (τ=1 sec), i.e. emphasize again that count down of time t* of one ply for team A is not over until the player SP_{A} repeatedly presses the button 6. Then, according to the specified turn the player FP_{B} gets the right to make 9-th ply with a black piece; at this instant DIS 4 reads: 18 min 14 sec; LED 57 is disabled (the other LED 57 and two LEDs 56 are activated). After making the ply with a black pawn “9 . . . e7-e5”, the player FP_{B} shortly presses the button 5 of the CC 2 (“Yes” at step 78); at this instant DISs 4 of both CCs 2 read: 17 min 7 sec, i.e. the FP₂ spent 1 min 7 sec for thinking over the move. After transmitting the 9-th ply via link 72, the SP_{B} repeats the ply “9 . . . e7-e5” on his PD₂ and then presses the button 5 of his CC 2. Only then both CCs 2 switch simultaneously (step 79), i.e. the right to make 10-th ply (N_{w}=10) after disabling the LED 57 at PD₂ passes to the player SP_{A} (step 81). Due to a delay in repetition of 9-th ply by the player SP_{B} at the instant of his short-time depression of the button 5 DISs 4 of both CCs 2 read: 17 min 5 sec (τ=2 sec). The aforementioned steps are then repeated in respect of 10-th ply “10.c2-c3” with the only difference that the ply is made by the player SP_{A}, and the player FP_{A} repeats the ply. The same steps are also repeated in respect of 10-th ply with a black piece (N_{w}=10) “10 . . . Kb8-c6”, i.e. the player SP_{B} makes the ply and player FP_{B} repeats the ply. After expiration of the time limit T₀ (T₀=0) at one of the time limit displays (“Yes” at step 77), the game terminates (step 82). Note that the functions of LEDs 56, 57 can be performed by LEDs 50, 51, e.g. by intermittently lighting to indicate the locking mode. Now consider some structural features of technical means used to implement steps 78, 79 and step 81. Step 81 is implemented on the basis of a device for locking the switching of the CC 2 included therein. In the simplest case this device is used to lock the CC switching when the switching has been made by a single player only. The locking device can be implemented either in software (FIG. 5-FIG. 11) or hardware. FIG. 4 shows a CC comprising a hardware LD 46. Its operation will be described on the example of the above algorithm of playing a chess game between two pairs of players. Assume that TU 39 generates signals of count down of accumulated time T at DIS 3 or DIS 4 only when logical one is present at input A1 or A2 of the TU 39, and logical zero is simultaneously present at the other input A2 or A1, respectively; the CCs retain the running time T count down mode at DIS 3 or DIS 4 in case of conversion of logical one to logical zero. The order of CC activation is determined by internal program in the TU 39. Assume that in the original state before 9-th ply output Q of the trigger 47 in both clocks has a voltage corresponding to logical one (log.“1”), i.e. log.“1” and log.“0” are applied to inputs A1 and A2 (LED 50 and DIS 3 are activated). Then, after a short-time depression by the player FP₁ on the button 6 of the CC (“Yes” at step 78) contacts 43 at his CC close, this resulting in log.“0” appearing at output Q of the trigger 47. It is evident from the schematic diagram that only after pressing the button 6 of the second CC 2 DIS 4 will be activated and DIS 3 will be disabled on both CCs. Actually, in this case log.“1” appears at input A2 of the TU 39 of both CCs (at this instant log.“0” is present at two inputs A1), which is the necessary condition for switching the VCC 63. Using the circuits shown in FIGS. 7 to 11, the VCC 63 will be automatically switched immediately after a chess move, e.g. using a mouse pointing device. In this case the turn of moving, by players FP₁ 19, SP, 20 and FP₂ 21, SP₂ 22, chess pieces on respective SC₁ 58, SC₁ 59, SC₁ 60, SC₁ 61 is specified by locking a respective input device, such as a keyboard or a mouse pointing device. With the circuits shown in FIGS. 7 to 11, delay τ in switching the VCC 63 will be generally determined by the time of propagation of a respective signal between service computers and chess game computers SC₁ 58, SC₁ 59, SC₁ 60, SC₁ 61, CGC₁ 66 and CGC₂ 67, and the time of processing the signal. In conclusion it may be said that various embodiments of portable device 71 for playing chess are possible. In one of the variants buttons 5, 6 for switching the CC 2 can be omitted, the switching being performed automatically, but only if steps 78, 79 (making i-th ply by a player of team A or B in accordance with the specified turn (step 78) and its repetition (step 79) by a second player of team A (B) at the other portable device 71) have been executed. As this takes place, microcomputers of portable devices 71 functioning as e.g. PPS 31, TU 39, control unit 41 and devices for locking them must be in the mode of active communication via wireless link 72.

### INDUSTRIAL APPLICABILITY

The invention can be used for organization of a world championship under the aegis of FIDE in pair category. High competition among computer companies for participation in this kind of chess games is explained by the fact that a variant of the game can be conducted not only between the pairs including two human players, but also between the pairs, each including a human player and a computer. In the latter case the human player may preliminary “train” his “partner”. Methods and means of such “training” may be used in manufacture of common computers. The invention can be used as a tutorial instead of the ordinary chess recommended by UNESCO to be used in schools worldwide. The invention can be also used in organization of mass production of portable devices for playing chess between at least two pairs of players.

1. A device for playing a chess game comprising: at least two playing fields (7, 62) divided into squares of two alternating colors, two sets of chess pieces, each set consisting of two groups (8, 9) of chess pieces (10 to 15), and two chess clocks (2), each chess clock having a timing unit (39) connected to two displays (3, 4) and to a control unit (41) for switching the displays (3, 4), said device characterized by further comprising data exchange means (23, 24, 25, 26, 27, 28) for exchanging data related to positions of the chess pieces (10 to 15) on the playing fields (7), each of the chess clocks (2) comprising a locking device (46), connected to the timing unit (39), for locking the control unit (41), wherein all timing units (39) of the chess clocks (2) are linked together.

2. The device according to claim 1, wherein the data exchange means for exchanging data related to positions of chess pieces (10 to 15) on playing fields (7) comprises at least two linked piece position displays (23, 24).

3. The device according to claim 1, wherein the locking devices or the timing units (39) communicate via a wireless link.

4. The device according to claim 1, wherein the data exchange means for exchanging data related to positions of chess pieces (10 to 15) on playing fields (7) comprises one or more wireless links.

5. The device according to claim 1, wherein the chess clocks (2) comprise indicators (56, 57) of activation of a locking device (46) for locking the control unit (41).

6. The device according to claim 1, further comprising at least two computers (58, 59), each computer including a unit for generating a playing field (7), a unit for generating a set of chess pieces (10 to 15) and a unit for generating chess clocks (2).

7. The device according to claim 1, comprising a device for locking a move of a piece on a playing field (7), e.g. a device for locking the means for exchanging data related to positions of chess pieces (8, 9) on playing fields (7, 62).

8. The device according to claim 7, further comprising a plurality of linked devices for locking a move of a piece (8, 9) on a playing field (7, 62).

9. A method of playing chess including a set of chess means such as playing fields (6, 7) with chess pieces (8, 9) arranged thereon and a plurality of chess clocks (2, 63), comprising alternatively moving by players, members of a first or second team, own chess pieces (8, 9) on a playing field (7) during a time limit allotted to each player (19, 20, 21, 22), said method characterized by using, in said set of chess means, respective devices for locking said chess means, e.g. a device (46) for locking the switching of a chess clock by a player; setting (75) a time limit for the first and second teams, the turn of moving the chess pieces (8, 9) by the players being specified by locking access to a predetermined chess means at a respective time.

10. The method according to claim 9, wherein using at least two locking devices the linked chess clocks are switched simultaneously only when each of the players, members of only the first or second team, has put them to switching mode.

11. The method according to claim 9, wherein a device for locking a piece move on a playing field (7, 62) locks access of respective players to moving a chess piece, e.g. by locking activation of a piece position display or by locking means for exchanging data related to chess piece positions on playing fields (7, 62).

12. The method according to claim 9, wherein at least one set of chess means including a playing field (62) with chess pieces arranged thereon and chess clocks (63) is generated on a display of a computer (58, 59, 60, 61), access to moving a chess piece being locked by locking an input device such as a keyboard or mouse connected to the computer.

13. The method according to claim 9, wherein the turn of moving chess pieces (8, 9) by players is specified (74) by storing a service routine in a memory of respective chess means.

14. The method according to claim 13, wherein the turn of moving chess pieces (8, 9) by players is specified (74) in accordance with a predetermined law.

15. The method according to claims 13, wherein said law is determined (74) as a deterministic or random function.

16. The method according to claim 9, wherein at least one player, member of a first or second team, is a chess computer (66, 67) designed for playing a chess game.
